(19) United States
(12) Patent Application Publication
(10) Pub. No.: US 2006/0240173 A1
(43) Pub. Date: Oct. 26, 2006

(54) PROTEIN ENHANCED LOW CARBOHYDRATE SNACK FOOD

(76) Inventor: James Carl Schmidt, Grosse Point Park, MI (US)

Correspondence Address: FALKOWSKI PLLC, P.O. BOX 650, NOVI, MI, 48376-0650, US

(21) Appl. No.: 11/428,377

(22) Filed: Jun. 30, 2006

Related U.S. Application Data
(63) Continuation of application No. 10/636,069, filed on Aug. 6, 2003, now abandoned.

(51) Int. Cl. A23J 1/00

(52) U.S. Cl. 426/656

(57) ABSTRACT

A protein enhanced, wafer having protein material in a concentration of about 26% to about 99% of the wafer is described, as well as methods of making the same.

### RELATED APPLICATIONS

This application claims priority from and is a continuation of the utility patent application titled “PROTEIN ENHANCED LOW CARBOHYDRATE SNACK FOOD” (Ser. No. 10/636,069) that was filed on Aug. 6, 2006, the contents of which are herein incorporated by reference in their entirety.

### BACKGROUND

The current candy and confection industry is based upon refined sugar, high-fructose corn syrups and other sweeteners that cause excessive elevation of blood sugar when eaten. The excessive blood sugar not used by the body is converted to fat as an energy source for later use. High blood sugar resulting from eating sugar-carbohydrate rich candies and confections is believed to promote obesity and diabetes.

There has been a trend lately to use foods low in carbohydrates, especially those high in protein, as part of a diet advocated for many years by diet guru Robert Atkins, M.D., and often called the Atkins diet. After decades of medical ridicule, the Atkins diet recently gained some credibility with the release of widely publicized research from Duke University. Dieters in the Atkins-funded study lost an average of 20 pounds in six months, and also saw improvements in cholesterol and other cardiovascular risk factors.

Low carbohydrate diets, such as the Atkins diet, cause the body to burn fat and muscle tissue to obtain needed energy because there are no carbohydrates to supply the energy. To prevent losses of muscle tissue a dieter should consume greater amounts of protein, since protein supplies energy and builds and repairs muscle tissue.

Most snack foods contain high amounts of refined sugar. Those snack foods that are low in carbohydrates typically are not high in protein. Many traditional low carbohydrate snack foods typically do not have a flavor that is favorable to a dieter's taste, and adding protein to such foods makes it harder to create a favorable flavor.

Conventional efforts to make a protein enhanced, low carbohydrate wafer have also failed because previous wafer batters were unable to maintain proteins in a stable suspension. The proteins could not remain in a suspension because their natural density and inherent isoelectric pH caused them to resist suspension and/or to resist bonding in the presence of one or more different proteins. The proteins' isoelectric pH also caused them to repel each other rather than bond together. When a batter or mixture was able to suspend the proteins, it required high moisture levels and mechanical action to temporarily maintain the suspension and to allow the batter to be pumped and distributed throughout the manufacturing process.

Thus, it has been difficult to make a protein enhanced, low carbohydrate wafer and snack food for use in a low carbohydrate diet, such as the Atkins diet. The result is that it is more difficult for an individual to follow the diet and obtain the benefits therefrom.

### SUMMARY

This specification describes a protein enhanced, low carbohydrate wafer having protein material in a concentration of about 26% to about 99% of the wafer, as well as methods of making the same.

### DETAILED DESCRIPTION

The following description provides specific details of embodiments of the invention. The skilled artisan will understand, however, that embodiments of the invention can be practiced without employing these specific details. Indeed, embodiments of the invention can be practiced by modifying the illustrated method and resulting product and can be used in conjunction with apparatus and techniques conventionally used in the industry. Embodiments of the invention, however, could easily be adapted for other uses. For example, other ingredients, such as vitamins or minerals, could be added to the wafer to provide additional benefits, or to make the wafer for a specific diet other than the Atkins diet. The blend of proteins could also be altered to achieve various textures and flavors.

This specification describes protein enhanced, low carbohydrate snack foods, particularly wafers and snack foods incorporating wafers, and methods for making and using such foods. The protein enhanced, low carbohydrate wafer is made from a unique blend, formulation and precise technique and sequence of combining food-based proteins and other ingredients. The precise sequence allows the proteins to remain bonded in a stable suspension in a base wafer batter, and does not require high moisture content or mechanical action to maintain the suspension. The base wafer batter is then deposited on a wafer plate and baked into a wafer sheet that can be shaped and used in conjunction with other sugar-free coatings and dressings, such as chocolate, cream fillings and icings, to make a protein enhanced, low carbohydrate snack food.

As used herein, “total carbohydrate content” refers to the sum total of all carbohydrates in the food. “Net effective carbohydrates” refers generally to those carbohydrates that have a significant impact on increasing blood glucose levels. Finally, all concentrations given herein are in terms of weight percent of the base wafer batter or wafer.

The present specification describes a protein enhanced, low carbohydrate wafer and base wafer batter, snack foods comprising the wafer, and methods of making the wafer. The wafer is made by baking a base wafer batter, which generally contains protein material, a sweetener, water, oil, an emulsifier, salts and seasonings or flavorings. The protein and carbohydrate content of the base wafer batter can be modified for various manufacturing and dietary requirements. For example, baking a base wafer batter having only protein and the above ingredients produces a pure protein wafer. In another aspect, starch may be blended into the base wafer batter to form a starch base wafer batter that produces a blended starch wafer having a lower concentration of protein, but allowing a higher speed of production.

The wafer and base wafer batter comprise protein material in order to minimize the adverse effects of a low carbohydrate diet, as previously described. Protein can comprise generally from about 1% to about 65% of the wafer batter. In one particular aspect, the wafer batter contains from about 10% to about 40% protein. Because baking the batter causes all, or nearly all, of the water to evaporate, the final wafer can comprise up to about 99% protein. In another aspect a pure protein wafer comprises at least about 94% protein. In another aspect, a blended starch wafer comprises about 26% protein.

The base wafer batter, wafer and snack foods comprising a wafer can have up to about 5 different proteins blended together. Each different blend of proteins contributes unique properties to the product, such as texture, flavor, durability and strength. In one aspect, the wafer and base wafer batter comprise about 3 different proteins. In another aspect, snack foods comprising the wafer have about 5 different proteins.

The protein material that can be used includes, but is not limited to, soy and soy isolates, whey and whey isolates, micro cross filtered whey isolates, wheat proteins (e.g., glutenir, gliadin, and gluten), isolated grain and vegetable based proteins, egg white protein, protein isolates, and albumen isolates. Vegetable based proteins include any vegetable in which proteins may be collected, whether condensed, accumulated or isolated. Examples of protein-providing vegetables include spelt, quinoa, amaranth, buckwheat, black rice, and the like.

In a particular aspect the wafer contains whey protein. Whey protein is available in a number of different types based upon the protein content of the whey source. The different whey sources that can be used in the wafer include, but are not limited to, whey protein concentrate, whey protein isolate, micro cross filtered whey protein isolate and hydrolyzed whey protein. In one aspect whey protein isolate is one of the proteins present in the base wafer batter and has a concentration of about 1 % to about 65%. In one particular aspect, the base wafer batter contains from about 5% to about 25% whey protein isolate. After baking the batter, the wafer can comprise up to about 99% whey protein isolate. In one particular aspect, the wafer comprises about 60% whey protein isolate.

This specification also describes a wafer that has soy protein. The greatest usage for soy proteins in baking is in combination with other ingredients, such as whey, to replace non-fat dry milk. The concentration of the particular blend is determined by the functional and/or nutritional requirements of the particular product. Defatted soy flour is the primary soy product used in these blends, but concentrates and isolates are also used in combination with whey and sodium or calcium caseinate for special applications, including cake mixes. Soy protein is available in soy flours, soy protein concentrates, and soy protein isolates. In one aspect, the base wafer batter comprises soy protein isolate in a concentration of about 1% to about 65%. In another aspect, the concentration of soy protein isolate in the base wafer batter can be about 5% to about 7%. After baking, the wafer can comprise up to about 99% soy protein isolate. In one particular aspect the wafer comprises about 15% soy protein isolate.

Also described herein is a wafer that contains a caseinate. Caseinates are used because of their emulsifying and stabilizing characteristics in nutritional foods and beverages. Because they typically comprise from about 85% to about 94% protein, they also serve as a source of protein. In one aspect, the ratio of caseinate to whey protein isolate in the base wafer batter is about 1:5.4 to about 1:5.7. In one aspect, caseinate is present in the wafer in a concentration of up to about 11%. In a particular aspect the wafer contains calcium caseinate in a concentration of about 10.7%. However, many other types of caseinates can be used, such as sodium caseinate, potassium caseinate, magnesium caseinate and ammonium caseinate.

Egg whites can also provide another good source of protein in a wafer. They can be liquid, which typically comprise about 10% protein, or powdered, which are nearly 100% protein. Powdered egg white proteins can typically comprise up to about 65% of the base wafer batter, but large amounts may impart an undesirable flavor or texture to the final wafer. Typically the egg white proteins comprise up to about 10% of the base wafer batter, and up to about 23% of the wafer. In one aspect, the base wafer batter comprises about 3% powdered egg whites, and in another aspect the wafer comprises about 8% powdered egg whites.

Water can also be added to the base wafer batter, but all, or nearly all, is evaporated during baking. The resulting wafer thus contains less than about 1% water. Water is added to the base wafer batter to serve two functions. First, the water provides an environment for the base wafer batter ingredients to interact. For example, the water provides a medium for the proteins to form into a bonded suspension with each other. Second, water facilitates the manufacturing of the wafers by easing the transport of the batter from the mixers to the wafer plates and ovens. Higher concentrations of water decrease the viscosity of the batter, thereby allowing it to flow and be pumped easier.

The amount of water added to the base wafer batter that is necessary for the water to be able to serve these two functions depends on two factors. The first is the type and amount of protein(s) added. Soy protein absorbs much more water than does whey protein, and thus requires the addition of greater amounts of water. Generally, the ratio of protein ingredients to water ranges from about 1:1.5 to about 1:2. The second factor is the batter consistency needed for easy movement of the batter through the manufacturing process. A highly viscous batter requires a strong pump to transport the batter throughout the process, but adding water decreases the batter viscosity, thus allowing transport with weaker pumps. In one aspect the base wafer batter comprises up to about 60% water.

The wafers may also include a wide variety of edible oils, fats and emulsifying agents well known to those of skill in the art. Typical oils that may be used include, but are not limited to, almond oil, canola oil, chili oil, coconut oil, corn oil, grapeseed oil, hazelnut oil, mustard oil, olive oil, palm oil, peanut oil, safflower oil, sesame oil, sunflower seeds, soybean oil, trans fatty acids, vegetable oil and walnut oil. In one aspect the wafer comprises canola oil in a concentration of up to about 5%. In another aspect the concentration of the emulsifier in the base wafer batter does not exceed 1%. The emulsifier used can be lecithin, which is found in egg yolks and legumes, such as soy. In one aspect the emulsifier used is soy lecithin.

To make the wafer more desirable, and to impart a better taste and flavor to it, a sweetening agent can be used in the wafer. Examples of sweetening agents include nutritive sweeteners and non-nutritive sweeteners. Nutritive sweeteners include, but are not limited to, refined sugars, sugar alcohols, and carbohydrate fiber sweeteners. Refined sugars include, but are not limited to, sucrose and fructose. Sugar alcohols include, but are not limited to, mannitol, sorbitol, xylitol, lactitol, isomalt, maltitol and hydrogenated starch hydrolysates (HSH). Carbohydrate fiber sweeteners include, but are not limited to, inulin and oligofructose. Non-nutritive sweeteners include, but are not limited to, aspartame, alitame, cyclamates, saccharin, acesulfame, sucralose, neohesperidin dihydrochalcone, stevia sweeteners, glycyrrhizin, thaumatin and the like, and mixtures thereof.

Refined sugars typically have a significant effect on increasing blood glucose levels. Sugar alcohols, fiber sweeteners and non-nutritive sweeteners, on the other hand, have little or no impact on blood glucose levels, and therefore can be consumed by people on low carbohydrate diets, such as the Atkins diet.

Generally, the concentration of the sweetening agent is determined by the desired flavor of the wafer. One particular sweetening agent that can be used in the wafer is sucralose. Because sucralose is nearly 600 times sweeter than sucrose, only minute amounts are needed; it can be present in the wafer in a concentration of about 0.01% or less, according to taste. In another aspect, the sweetening agent can be crystalline fructose. In one aspect, fructose is present in the wafer in a concentration of about 1%. In yet another aspect the sweetening agent comprises inulin or oligofructose.

The wafer may also comprise salts, seasonings and/or flavorings to make it more desirable to the taste. The concentration of salt, seasonings and flavorings can be adjusted according to need and to taste. Examples of seasonings and flavorings include, but are not limited to, mint, peppermint, cinnamon, vanilla, fruit, fruit extracts and essences, nut extracts, chili pepper, chocolate, caramel, peanut butter, sarsaparilla, sassafras, wild cherry, wintergreen, ginger, nutmeg, honey, malt, grain flavors, paprika, garlic and others well known to those of skill in the art.

The wafer may also contain starches blended in for variations of characteristics for specific manufacturing and dietary requirements and benefits. Starch can be present in the wafer in a concentration of up to about 65%. Typically the added starch can be, but is not limited to, Hi-maize flour, pastry flour, enriched flour, bleached wheat flour, cornstarch, tapioca, arrowroot, cassava flour, potato starch, kudzu powder, lotus root flour, sago, sahlab, sorghum starch, soy starch, mochiko, and the like. Hi-maize is a natural, unmodified, food grade, high amylose maize starch marketed by Penford Australia Ltd.

One specific manufacturing benefit provided by adding starch to the base wafer batter is that it can be mixed and transported much quicker than can a base wafer batter without blended starch. A dietary benefit provided by Hi-maize flour is that it is rich in fiber and resistant starch, and thereby does not significantly affect blood glucose levels. Pastry flour, which is a fine-textured, soft-wheat flour with a high starch content, has the benefit of making particularly tender cakes and pastries. Pastry flour can be present in the base wafer batter in a concentration of about 30%, and in the wafer in a concentration of about 64%.

Wafers are typically light and airy foods, but adding a starch to the base wafer batter thickens the batter. A leavener can be added to the base wafer batter to lighten the texture and increase the volume of the wafer. The concentration of leavener in the base wafer batter depends on the unique structure of the specific blend of proteins and/or starches. Generally, the base wafer batter can comprise up to about 3% leavener. In one aspect, the leavener comprises up to about 5% of the starch added. In another aspect, the leavener comprises up to about 10% of the protein concentration. Typical leaveners include baking powder, baking soda and yeast. Baking soda produces carbon dioxide gas bubbles, thereby causing a dough or batter to rise. The base wafer batter can contain baking soda in a concentration of about 1.2%.

The process for making the wafer is generally a two-step process comprising making a base wafer batter and baking the batter in an oven to make a wafer sheet. A protein enhanced, low carbohydrate base wafer batter is made by a unique process and precise sequence of mixing and adding proteins and other ingredients. The precise sequence allows the proteins to remain in suspension in the form of either a protein base wafer batter or a starch base wafer batter. The batter can then be baked into a wafer sheet having a homogeneous and continuous composition. Without the suspension, the wafer sheet would not be homogeneous or continuous. The wafer sheet can then be cut, formed or shaped for use in wafers, crisps, chips, puffs, sheets, cookies, cones and other confectionery items.

A base wafer batter is made by first creating a solution of egg whites, water and emulsifiers. In one aspect this solution also contains salt because a salted solution of a fairly neutral pH level is beneficial for the denaturing (or opening up) of the proteins. Denaturing the proteins makes parts of the protein molecular chain available to bond to each other to form the suspension. In another aspect a sweetening agent is also added to this solution, although the sweetening agent may be added at any time in the process.

Once the solution is prepared, the proteins are then added in a precise sequence. The sequence of combining proteins typically depends on their density, isoelectric charges and bonding characteristics. Typically whey protein is added first; then wheat based proteins of gliadin, glutenir and gluten may be added; and finally soy is added last. Water may also then be added after the proteins to achieve the desired consistency and moisture content necessary for manufacturing and processing.

The base wafer batter made by this process has a high concentration of proteins and is referred to as a protein base wafer batter. A starch base wafer batter, having a lower concentration of protein but a high concentration of starch, is made in a process comprising first making a protein slurry and a starch slurry, and then mixing the slurries together.

The protein slurry is made in a manner similar to that of making a protein base wafer batter, as described above. First, water and egg whites are mixed together. Once these components are well mixed, the emulsifier and oil are then added and mixed in simultaneously. Once the oil is emulsified calcium caseinate is then added and mixed. Adding calcium caseinate causes a foam to form, but the foam recedes won mixing. The proteins are then added in the same precise sequence: first whey protein, then wheat proteins, then soy protein. In one aspect salt and baking soda may also be added and mixed to complete the protein slurry. A sweetener, such as sucralose, can typically be added to the mixture at any time. In one aspect, sucralose is added with the water and egg whites.

The starch slurry contains the starch that is to be blended with the base wafer batter. The starch slurry is formed by combining water, starch, an emulsifier, oil, salt and a leavener in a turbo mixer and mixing. When the components are well mixed, the protein slurry is then added to the starch slurry, and both slurries are mixed together for about 30 seconds in the turbo mixer to make the starch base wafer batter.

In both methods of making the base wafer batter, the sequence of adding proteins plays an important part in determining the moisture content of the batter, as well as the capability of the batter to keep the proteins in suspension. When whey and soy proteins are both added, the whey protein is added before the soy protein because soy protein absorbs great amounts of water very rapidly. Adding soy protein before the whey protein dries the mixture too much before the whey protein can be added, thereby effectively limiting the protein content of the wafer. This precise sequence of adding proteins maintains the desired consistency of the base wafer batter, and allows the final wafer to maintain a homogeneous composition with uniform properties, such as strength and flavor. It thus creates the most stable base wafer batter for processing and manufacturing, and for producing a finished wafer product with a high eating quality.

After the protein or starch base wafer batter is mixed, it can then be deposited on a wafer plate and baked into a wafer sheet. Baking the batter removes the water and hardens the batter into a sheet that can be used in the manufacturing of confectionary items. The bake temperature can range from about 140 degrees Celsius to about 165 degrees Celsius, and the bake time can range from about 1 minute, 30 seconds to about 2 minutes, 30 seconds.

Typically the bake temperature and bake time depend on the moisture content in the wafer batter. The wafer generally is baked long enough and at a temperature adequate to eliminate at least about 99% of the moisture. Because soy protein absorbs more water than whey protein, a wafer batter having a higher soy content can bake for a longer time and/or at an elevated temperature. A base wafer batter having a soy protein content of about 20% of the total protein content, or about 6% of the base wafer batter weight, can bake for about 1 minute, 52 seconds at 140 degree Celsius. A base wafer batter having a soy protein content of about 50% of the total protein content, or about 5% of the base wafer batter weight, can bake for about 1 minute, 34 seconds at 160 degrees Celsius. In one aspect, the bake temperature is about 165 degrees Celsius, and the bake time is about 2 minutes, 30 seconds. Those of skill in the art will understand what bake time and temperature should be used to produce a quality wafer.

Following the above process produces a wafer sheet that is high in protein and low in carbohydrates. The wafer sheet can then be formed during or after baking into various wafer shapes and sizes for use in snack foods, such as wafers, crisps, chips, puffs, sheets, cookies, cones, bars and exotic desserts, and can include coatings or dressings such as chocolate, cream fillings or icings.

To form a wafer after baking, a baked wafer sheet is cut or shaped into the desired wafer shape using typical cutting devices, such as knives or cookie cutters. To form the wafer during baking, the base wafer batter is poured into a wafer die of the desired shape, rather than into a wafer plate. The base wafer batter in the wafer die is then baked in an oven, after which the shaped wafer is removed from the die.

This specification describes a snack food that includes a cookie having a protein enhanced, low carbohydrate wafer. The cookie is made by first forming a wafer of the desired cookie shape by using typical cookie cutting equipment, or baking the wafer batter in a cookie die. In one aspect, after the wafer is formed it may be filled with a cream filling and formed into a sandwich type cookie. The cream filling may be a protein enhanced, low carbohydrate cream filling. A formed wafer may also be coated with chocolate and/or icing. Those skilled in the art will recognize that the cookie can contain any combination or configuration of cream fillings, icings and/or chocolates.

The wafer cookie generally contains more protein and fewer carbohydrates than typical sugar and sugar-free wafer cookies. Typical sugar free wafer cookies contain from about 10 to about 12 grams of carbohydrates per 29 gram serving from the use of flour products in the wafer, even though they may have sugar-free fillings and chocolates. The wafer described herein, however, has up to only about 4 grams of carbohydrates per 28 gram serving due to the elimination of flour products or the addition of resistant starches. Thus sugar-free snack foods that comprise the protein enhanced, low carbohydrate wafer herein described have about 6 to about 9 grams of carbohydrates per 28 gram serving. In these snack foods the net effective carbohydrate content is about 1 gram or less per 28 gram serving, and the protein content is about 6 to about 19 grams per 28 gram serving.

The principles, products and methods herein described can be better understood with a description of the following examples. It should be understood that the following are only examples and should not be used to limit the products an methods herein described to the methods and products described in the examples.

### EXAMPLE 1

A protein enhanced, low carbohydrate pure protein wafer was made from a protein base wafer batter having the composition given in Table 1a.

TABLE 1a

| | Weight % of Base |
|---|---|
| Ingredient | Wafer Batter |
| Water | 58.9 |
| Canola Oil | 1.0 |
| Soy Lecithin | <1 |
| Fructose (crystalline) | 1.0 |
| Protein | 38.5 |
| Egg Whites (powdered) | 3.1 |
| Calcium Caseinate | 4.4 |
| Whey Protein Isolate | 24.8 |
| Soy Protein Isolate | 6.2 |

The batter was prepared by performing the following steps. First, 410 grams of water were mixed with 30 grams of powdered egg whites. The mixture was then mixed until it became homogeneous. Then canola oil and soy lecithin were mixed in simultaneously. The canola oil was added very slowly under rapid mixing. After the oil became emulsified, the remaining dry ingredients of calcium caseinate and crystalline fructose were then added. Next, the proteins were added: first whey protein isolate, then soy protein isolate. The soy protein isolate was added after the whey protein isolate in order to keep the proteins in suspension and to prevent the soy from absorbing too much water. Finally, 160 grams of additional water were mixed in to reach the desired consistency for ease in manufacturing and processing. This protein base wafer batter was then deposited onto a wafer plate and baked for 1 minute, 52 seconds at 140 degrees Celsius. The resulting pure protein wafer had the composition shown in Table 1 b.

TABLE 1b

| Ingredient | Weight % of Wafer |
|---|---|
| Water | <1 |
| Fructose (crystalline) | 2.5 |
| Canola Oil | 2.5 |
| Soy Lecithin | 1.3 |
| Protein | 93.7 |
| Egg Whites (powdered) | 7.5 |
| Calcium Caseinate | 10.7 |
| Whey Protein Isolate | 60.4 |
| Soy Protein Isolate | 15.1 |

### EXAMPLE 2

A protein enhanced, low carbohydrate blended starch wafer was made from a starch base wafer batter. The starch base wafer batter was made by mixing a protein slurry with a starch slurry, the compositions of which are given in Table 2.

TABLE 2a

| | | |
|---|---|---|
| | Weight of Ingredient | Weight % of |
| Ingredient | Added (lbs) | Slurry |

Protein Slurry

| | | |
|---|---|---|
| Water | 23.4 | 58.2 |
| Egg Whites (powdered) | 1.1 | 2.7 |
| Canola Oil | 1.6 | 4.0 |
| Soy Lecithin | 0.5 | 1.2 |
| Calcium Caseinate | 1.1 | 2.7 |
| Sucralose | 2.4 grams | <1 |
| Whey Protein Isolate | 6.0 | 14.9 |
| Soy Protein Isolate | 6.0 | 14.9 |
| Salt | 0.2 | <1 |
| Baking Soda | 0.2 | <1 |

Starch Slurry

| | | |
|---|---|---|
| Water | 39.5 | 51.0 |
| Pastry Flour | 35.0 | 45.2 |
| Soy Lecithin | 0.4 | <1 |
| Canola Oil | 1.2 | 1.5 |
| Salt | 0.2 | <1 |
| Baking Soda | 1.2 | 1.5 |

The protein slurry was made by mixing water and powdered egg whites in a Hobart mixer. Once the mixture became homogeneous, sucralose, canola oil and soy lecithin were added and mixed. After the oil became fully emulsified, calcium caseinate was added. The calcium caseinate caused foam to form on the surface of the mixture, but subsequent mixing made the foam recede. Next the whey protein isolate was added and mixed. Once the whey was completely mixed, soy protein isolate was added to the mixture and mixed. Finally, the salt and baking soda were added and mixed to finish the protein slurry.

The starch slurry was made by mixing all components simultaneously in a turbo mixer and mixing. Once the components were well mixed, the protein slurry was added to the starch slurry in the turbo mixer, and mixed for 30 seconds to make the starch base wafer batter. The wafer batter was then deposited on wafer sheet and baked for 1 minute, 34 seconds at 160 degrees Celsius. The resulting wafer had the composition shown in Table 2b.

TABLE 2b

| Ingredient | Weight % of Wafer |
|---|---|
| Water | <1 |
| Canola Oil | 5.1 |
| Soy Lecithin | 1.6 |
| Sucralose | <1 |
| Protein | 26.0 |
| Egg Whites (powdered) | 2.0 |
| Calcium Caseinate | 2.0 |
| Whey Protein Isolate | 11.0 |
| Soy Protein Isolate | 11.0 |
| Salt | <1 |
| Baking Soda | 2.6 |
| Flour | 64.0 |

### EXAMPLE 3

A high protein, low carbohydrate cookie was made using the pure protein wafer of Example 1. The cookie was made by forming the wafer to the desired shape of the cookie by typical cookie dies and cutting equipment. The wafer batter was then baked and the resulting wafer was filled with a sugar-free cream filling and formed into a sandwich type cookie. The resulting cookie had the nutritional composition shown in Table 3.

TABLE 3

| | Weight (g) per 28 g |
|---|---|
| | Cookie Serving |
| Protein | 8-19 |
| Total Carbohydrates | 9 |
| Sugar Alcohol | 8 |
| Fiber | 1 |
| Net Effective Carbohydrates | <1 |

### EXAMPLE 4

A high protein, low carbohydrate cookie was made by the process of Example 3, except that the high protein, low carbohydrate blended starch wafer of Example 2 was used instead of the pure protein wafer of Example 1. The resulting cookie had the nutritional composition shown in Table 4.

TABLE 4

| | Weight (g) per 28 g |
|---|---|
| | Cookie Serving |
| Protein | 6 |
| Total Carbohydrates | 11 |
| Sugar Alcohol | 9 |
| Fiber | 1 |
| Net Effective Carbohydrates | 1 |

### EXAMPLE 5

For purposes of comparison, a conventional sugar wafer cookie has the nutritional composition shown in Table 5a, and a conventional sugar-free wafer cookie has the composition shown in Table 5b.

TABLE 5a

| | Weight (g) per 28 g |
|---|---|
| | Cookie Serving |
| Protein | 1 |
| Total Carbohydrates | 21 |
| Sugar Alcohol | 0 |
| Fiber | 0 |
| Net Effective Carbohydrates | 21 |

TABLE 5b

| | Weight (g) per 28 g |
|---|---|
| | Cookie Serving |
| Protein | 1 |
| Total Carbohydrates | 18 |
| Sugar Alcohol | 10 |
| Fiber | 0 |
| Net Effective Carbohydrates | 8 |

It is to be understood that the above-described arrangements are only illustrative of the application of the principles described herein. Modifications and alterations of may be devised by those skilled in the art without departing from the spirit and scope of the products and methods described herein, and the appended claims are intended to cover such modifications and arrangements.

1. A wafer cookie, comprising:
protein material, wherein said protein material comprises, by weight, between about 26% and about 99% of a wafer cookie, said wafer cookie being light and airy.

2. The wafer cookie of claim 1, wherein said wafer cookie is created by pumping a wafer batter, said batter including:
flavorings or seasonings;
oil; and
an emulsifier.

3. The wafer cookie of claim 1, wherein said protein material is whey protein, wheat protein, soy protein, calcium caseinate, egg white protein, or a combination thereof, and wherein mechanical action is not used to maintain a suspension of the protein materials.

4. The wafer cookie of claim 1, comprising:
caseinate; and
whey protein isolate;
wherein the ratio of caseinate to whey protein isolate is about 1:5:4 to about 1:5:7, and wherein the wafer cookie includes a homogeneous wafer sheet.

5. The wafer cookie of claim 1, comprising:
whey protein isolate; and
soy protein isolate, wherein the whey protein isolate is added to a base wafer batter before the soy protein isolate.

6. The wafer cookie of claim 5, wherein the ratio of soy protein isolate to whey protein isolate ranges from about 1:1 to about 1:4, and wherein the density of a wafer in said wafer cookie is about between 100 grams to 120 grams per 450 mm×350 mm sheet.

7. A wafer cookie, comprising by weight:
from about 11% to about 99% whey protein isolate;
from about 11% to about 99% soy protein isolate;
from about 2% to about 11% calcium caseinate; and
from about 2% to about 23% egg white protein, wherein said wafer cookie is light and airy.

8. The wafer cookie of claim 7, wherein:
whey protein isolate comprises about 60%;
soy protein isolate comprises about 15%;
calcium caseinate comprises about 11%; and
egg white protein comprises about 8%,
wherein said soy protein isolate is added after said whey protein isolate.

9. The wafer cookie of claim 7, further comprising up to about 99% by weight wheat protein, wherein said whey protein isolate and said soy protein isolate are bonded together in a liquefied form.

10. The wafer cookie of claim 1, further comprising:
starch;
wherein said starch comprises up to about 65% of said wafer cookie,
and wherein said starch is used to make a starch slurry that is blended with a base wafer batter.

11. The wafer cookie of claim 10, wherein said starch is pastry flour, Hi-maize flour or wheat flour, wherein the base wafer batter comprises up to about 3% leavener, and wherein the base wafer batter is a pumpable fluid batter.

12. The wafer cookie of claim 10, wherein:
said at least one protein material comprises about 26% by weight of said wafer cookie and
said starch comprises about 64% by weight of said wafer cookie.

13. The wafer cookie of claim 10, wherein said protein material comprises:
whey protein isolate comprising about 11% by weight of said wafer cookie;
soy protein isolate comprising about 11% by weight of said wafer cookie;
calcium caseinate comprising about 2% by weight of said wafer cookie; and
egg white proteins comprising about 2% by weight of said wafer cookie.

14. The wafer cookie of claim 13, further comprising wheat proteins.

15. A wafer cookie, comprising:
a protein material, wherein said protein material comprises, by weight, between about 26% and about 99% of a wafer cookie;
wherein said protein material includes a plurality of different protein types that are bonded in a liquefied batter capable of being pumped.
